(19) United States
(12) Patent Application Publication
(10) Pub. No.: US 2014/0365659 A1
(43) Pub. Date: Dec. 11, 2014

(54) LOAD CONTROLLER FRAMEWORK

(71) Applicants: Olaf Schmidt, Walldorf (DE); Martin P. Fischer, Heidelberg (DE)

(72) Inventors: Olaf Schmidt, Walldorf (DE); Martin P. Fischer, Heidelberg (DE)

(73) Assignee: SAP AG, Walldorf (DE)

(21) Appl. No.: 13/910,461

(22) Filed: Jun. 5, 2013

(51) Int. Cl. H04L 12/911; G06F 11/263

(52) U.S. Cl. CPC H04L 47/821; G06F 11/263
USPC 709/226; 714/32

(57) ABSTRACT

The present disclosure involves systems, software, and computer-implemented methods for controlling service load in a cloud-based system. An example method includes receiving a first request for the network service from a client, evaluating a load condition associated with the network service, the load condition indicating an availability of the network service to receive requests, returning a unique token associated with the first request to the client in response to the load condition indicating that the network service is not available to receive the requests, receiving a second request for the network service from the client, the second request including at least a portion of the first request and the unique token, evaluating the load condition associated with the network service, and prioritizing the second request based on the unique token in response to the load condition indicating that the network service is available to receive the requests.

### TECHNICAL FIELD

The present disclosure involves systems, software, and computer-implemented methods for controlling service load in a cloud-based system.

### BACKGROUND

Cloud-based systems are generally distributed systems including multiple components connected by a network. Cloud-based systems may be used to implement network services that receive requests from clients and provide responses over a network. Load conditions associated with the network services may cause the services to be unavailable to process requests from clients.

### SUMMARY

The present disclosure involves systems, software, and computer-implemented methods for controlling application load in a cloud-based system. In one general aspect, an example method includes receiving a first request for the network service from a client, evaluating a load condition associated with the network service, the load condition indicating an availability of the network service to receive requests, returning a unique token associated with the first request to the client in response to the load condition indicating that the network service is not available to receive the requests, receiving a second request for the network service from the client, the second request including at least a portion of the first request and the unique token, evaluating the load condition associated with the network service, and prioritizing the second request based on the unique token in response to the load condition indicating that the network service is available to receive the requests.

While generally described as computer-implemented software embodied on non-transitory, tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for controlling service load in a cloud-based system.

FIG. 2 is a message flow diagram showing example interactions between a client, a cloud system, and a network service for controlling service load.

FIG. 3 is a flowchart of an example method for controlling service load in a cloud-based system.

FIG. 4 is a flowchart of an example method for evaluating a load condition associated with a network service.

### DETAILED DESCRIPTION

The present disclosure involves systems, software, and computer-implemented methods for controlling service load in a cloud-based system.

Many applications utilize cloud-based systems to retrieve business data from network services. The network services may be integrated into the cloud system or implemented on computing devices external to the cloud system. For example, an enterprise resource planning (ERP) service associated with a customer may be hosted on the customer premise (e.g., an “on-premise system”), where access to the service may be brokered by the cloud system. By allowing network access to services hosted on such on-premise systems, a high risk that too many requests may overload the on-premise system exists. For example, an on-premise system may not be able to process as many requests as a cloud system due to lack of processing power or network bandwidth. Such overloading may lead to the network service responding slowly to requests for data or may slow down company critical processes on the on-premise systems. In addition to on-premise systems, components and services within the cloud system may also be subject to the same type of overloading.

The present solution provides a cloud-based solution that protects network services from being overloaded by requests. Client requests for network services are brokered by the cloud system, which in turn controls the volume of requests being sent to each network service. When a request for a certain network service is received, a load condition associated with the network service is evaluated to determine if the network service can process the request. If it is determined that the network service is not available to process requests at this time due to load, a unique token is returned to the client. The client may resubmit the request with this unique token to have the resubmitted request prioritized over other requests (submitted without their own respective unique token) if the network service is subsequently available. For example, if a client submits a request for an ERP service, the cloud system may evaluate a load condition associated with an ERP service. If it is determined that the ERP service is currently handling a number of requests greater than a pre-defined or dynamically determined load threshold, the cloud system may return the unique token to the client. The client may then resubmit the request with the unique token. If the ERP service is handling a number of requests less than the threshold when the resubmitted request is received, the resubmitted request may be prioritized above other requests that are currently pending for the ERP service. This prioritization may be implemented by inserting the resubmitted request into a priority queue containing the request for the ERP service in an advanced position such that it will be processed sooner by the ERP service than other non-prioritized requests.

In some cases, the load condition may be evaluated by analyzing statistics associated with the network service to determine whether the network service is available. The load condition may also be evaluated by checking a status indication sent by the network service itself. For example, the network service may send a message to the cloud system to indicate that it is under load and cannot process anymore requests currently.

The present solution may provide several potential advantages. By providing a common framework through which network service load can be managed, developers of network services may be relieved of having to handle such load conditions thus simplifying the process of developing network services. Further, the token mechanism described above may provide greater performance to clients requesting network services that are under load than a standard retry algorithm, as subsequent retransmissions will be given greater priority.

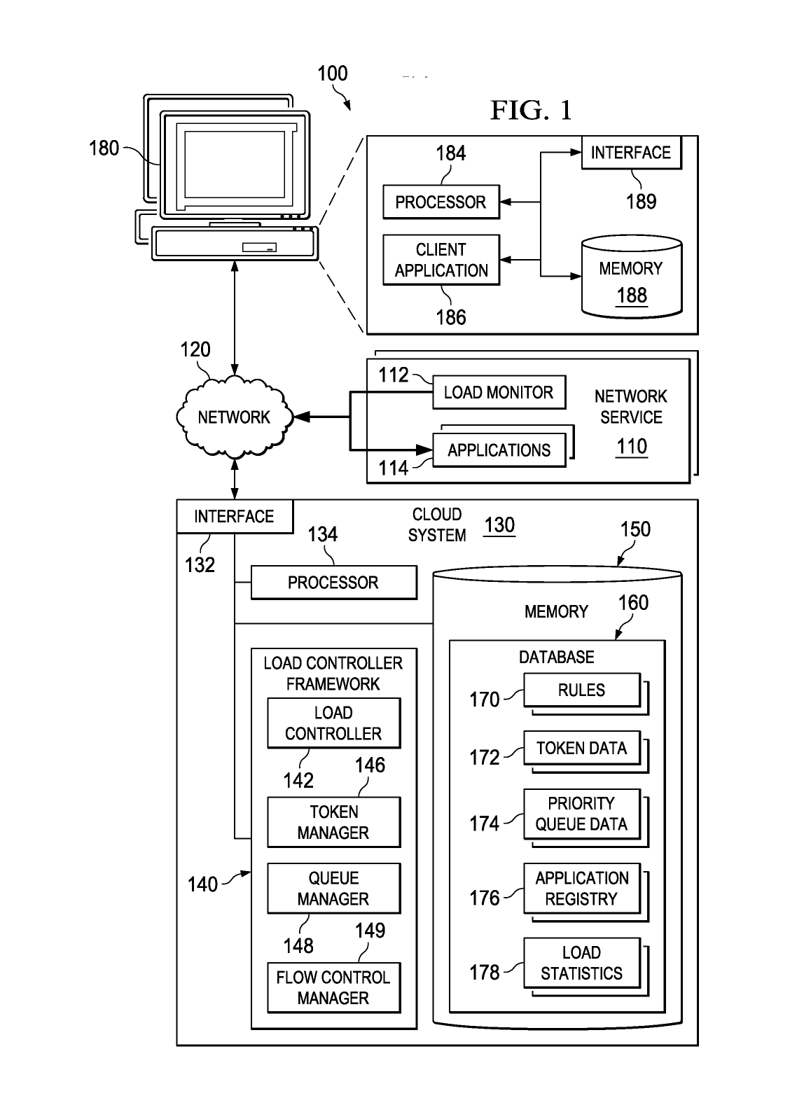

FIG. 1 is a block diagram illustrating an example system for controlling service load in a cloud-based system. As shown, the example environment 100 includes a cloud system 130, one or more clients 180 connected to the cloud system 130 by a network 120, and a network service 110 connected to the cloud system 130 by the network 120. In operation, the cloud system 130 may receive a request from the client 180 for the network service 110. The cloud system 130 may evaluate a load condition associated with the network service 110 and, based on this evaluation, may return a token to the client 180 if the network service is currently under load. When the client 180 resubmits the request with this token, the cloud system 130 may analyze the token to determine how to prioritize the resubmitted request.

In the illustrated implementation, the example environment 100 includes a cloud system 130. At a high level, the cloud system 130 comprises an electronic computing device operable to broker requests between the client 180 and the network services 110 based on load conditions associated with the network services 110. The cloud system 130 may be a distributed system including different servers and components. In some implementations, the cloud system 130 may be a combination of hardware components and software components executing the order to broker the request from the client 180 for the network services 110. The cloud system 130 may also be the single computing device performing this brokering.

In some implementations, the cloud system 130 may be a web service that is accessible via standard web protocols, such as, for example, Hypertext Transfer Protocol (HTTP), Simple Object Access Protocol (SOAP), or any other suitable protocol or combination of protocols. In some cases, the cloud system 130 may provide an Application Programming Interface (API) through which one or more clients 180 may submit requests to the network services 110. In some implementations, this protocol may be specific to the individual network service, or maybe generalized for use with many network services.

As used in the present disclosure, the term “computer” is intended to encompass any suitable processing device. For example, although FIG. 1 illustrates a cloud system 130, environment 100 can be implemented using two or more servers, as well as computers other than servers, including a server pool. Indeed, cloud system 130 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, illustrated cloud system 130 may be adapted to execute any operating system, including Linux, UNIX, Windows, Mac OS®, Java™, Android™, iOS or any other suitable operating system. According to one implementation, cloud system 130 may also include or be communicably coupled with an e-mail server, a Web server, a caching server, a streaming data server, and/or other suitable server.

The cloud system 130 also includes an interface 132, a processor 134, and a memory 150. The interface 132 is used by the cloud system 130 for communicating with other systems in a distributed environment—including within the environment 100—connected to the network 120; for example, the clients 180, as well as other systems communicably coupled to the network 120 (not illustrated). Generally, the interface 132 comprises logic encoded in software and/or hardware in a suitable combination and operable to communicate with the network 120. More specifically, the interface 132 may comprise software supporting one or more communication protocols associated with communications such that the network 120 or interface's hardware is operable to communicate physical signals within and outside of the illustrated environment 100.

As illustrated in FIG. 1, the cloud system 130 includes a processor 134. Although illustrated as a single processor 134 in FIG. 1, two or more processors may be used according to particular needs, desires, or particular implementations of environment 100. Each processor 134 may be a central processing unit (CPU), a blade, an application specific integrated circuit (ASIC), a field-programmable gate array (FPGA), or another suitable component. Generally, the processor 134 executes instructions and manipulates data to perform the operations of the cloud system 130. Specifically, the processor 134 may execute the functionality required to receive and respond to requests from the clients 180.

In the illustrated implementation, the cloud system 130 includes a load controller framework 140. In some implementations, the load controller framework 140 may be a software program or set of software programs operable to evaluate and control load conditions associated with the network services 110. The load controller framework 140 may also be any combination of hardware and software components operable to perform the described load control. The various components included in the load controller framework 140 and described below may also be software, hardware, or any combination of software and hardware components.

The load controller framework 140 may include a load controller 142. In operation, the load controller 142 may receive a request from the client 180 via the network 120. The load controller 142 may determine the network service 110 associated with the request and evaluate the current load condition of the network service 110. For example, the load controller 142 may analyze statistics associated with the network service 110 indicating a number of requests sent to the network service in a recent time period, a total amount of data sent to the network service 110 in the time period, a total number of outstanding requests that the network service 110 is currently processing, or any other suitable statistic. The load controller 142 may further analyze rules 170 to determine whether any of the statistics associated with the network service 110 are above thresholds specified by the rules 170 and thus indicate that the network service 110 is unavailable to process requests. For example, a rule 170 may indicate that the network service 110 may have a maximum of ten requests pending at any time. If the load controller 142 receives a request for the network service 110 while the network service 110 has ten requests pending, the load controller 142 may reject the request and issue a token to the requesting client.

In some cases, the load controller 142 may be operable to issue tokens for requests that cannot be processed at the current time by the network service 110. In some implementations, these tokens include a globally unique identifier (GUID) that uniquely identifies the token on the cloud system 130. When a client resubmits a request with a token, load controller 142 may consult the token manager 146 to determine how to handle the request. The token manager 146 may consult the token data 172 in the database 160 to determine statistics associated with the submitted token and may cause the request to be treated differently based on the statistics. For example, if the token data 172 indicates that a token has been resubmitted fifteen times and the network service 110 has been unavailable each time, such a request may be prioritized by the token manager 146 above a request associated with the token that has only been resubmitted once. By performing this prioritization, older requests are processed first when the network service 110 becomes available to process requests.

In some implementations, the load controller 142 may refuse requests for the network service 110 for an amount of time configured in the rules 170 if a load condition is observed. For example, a rule 170 may state that the network service 110 should not have any requests sent to it for one second after load condition is observed in order to give the condition time to clear.

In some implementations, the load controller 142 may examine a current load state of the network service 110 as indicated by the network service 110 itself, such as, for example, by sending flow control indications to the cloud system 130. Such a flow control indication may be processed by the flow control manager 149 and stored in the database 160 for use by the load controller 142.

In the illustrated implementation, the load controller framework 140 also includes a queue manager 148. In some implementations, requests sent by the client 180 for the network service 110 may be entered into the priority queue and processed in order according to the queue. The queue manager 148 may be operable to push and pop requests onto and off of the priority queue based on the prioritization data generated by the load controller 142 and the token manager 146. For example, the load controller 142 may instruct the queue manager 148 that a certain request be prioritized. The queue manager 148 may then insert the prioritized request at the front of the priority queue, such that it will be processed before all other pending requests.

The queue manager 148 may also be operable to clear all requests from the priority queue when a load condition associated with the network service 110 is detected. For example, if a flow control indication is received from the network service 110, the queue manager 148 may remove all requests that are currently pending in the priority queue for the network service 110 and cause the load controller 142 to issue tokens for each request.

The load controller framework 140 may also include a flow control manager 149. In some implementations, the flow control manager 149 is operable to receive a flow control indication from the network service 110 indicating that the network service 110 is currently unavailable due to load. For example, the network service 110 may detect that its processor is running at one hundred percent utilization and may generate a flow control indication in order to prevent additional requests from being sent to the network service 110. The flow control manager 149 may receive this indication and may store an indication that the network service 110 is currently unavailable in the database 160, such as in the load statistics 178.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The cloud system 130 also includes a memory 150 or multiple memories 150. The memory 150 may include any type of memory or database module and may take the form of volatile and/or non-volatile memory including, without limitation, magnetic media, optical media, random access memory (RAM), read-only memory (ROM), removable media, or any other suitable local or remote memory component. The memory 150 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the cloud system 130. Additionally, the memory 150 may include any other appropriate data, such as VPN applications, firmware logs and policies, firewall policies, a security or access log, print or other reporting files, as well as others.

As illustrated in FIG. 1, memory 150 includes or references data and information associated with and/or related to providing the network service load control. As illustrated, memory 150 includes a database 160. The database 160 may be one of or a combination of several commercially available database and non-database products. Acceptable products include, but are not limited to, SAP® HANA DB, SAP® MaxDB, Sybase® ASE, Oracle® databases, IBM® Informix® databases, DB2, MySQL, Microsoft SQL Server®, Ingres®, PostgreSQL, Teradata, Amazon SimpleDB, and Microsoft® Excel, as well as other suitable database and non-database products. Further, database 160 may be operable to process queries specified in any structured or other query language such as, for example, Structured Query Language (SQL).

As shown, the database 160 includes one or more rules 170. In some implementations, the rules 170 may specify thresholds for various statistics associated with the network service 110. For example, a rule 170 may specify that more than ten pending requests for a certain network service indicates that the network service is unavailable. The rules 170 may also specify actions to take when a network service 110 is observed to be under load. These actions may include, but are not limited to, issuing tokens for all requests until the load condition passes, issuing tokens for all requests for a certain amount of time, resetting the network service 110, or any other suitable action. As discussed previously, the rules 170 may be interpreted by the load controller 142 in order to determine how to broker requests. In some implementations, each rule 170 may be associated with one of the network services 110. Each rule 170 may also be associated with two or more network services 110.

In some implementations, the one or more rules 170 may be statically defined such that the rules 170 specify numeric values for various statistical thresholds associated with the network service 110. The one or more rules 170 may also be determined dynamically based on runtime conditions associated with the network service 110. For example, the one or more rules 170 may state that the network service 110 can have ten pending requests if a server associated with the network service 110 has a central processing unit (CPU) utilization less than ninety percent.

The database 160 also includes token data 172. The token data 172 may include a record for each token that has been issued for a request. In some implementations, the token data 172 may include a record for both pending tokens and tokens that have already been used to resubmit a request. Each record included in the token data 172 may include the GUID associated with the token, as well as an indication of the client to whom the token has been issued. The token data 172 may include statistics associated with tokens issued by the load controller 142 for requests that cannot be processed due to load. For example, the token data 172 may indicate the number of times the token has been resubmitted which indicates the number of times the associated request has failed.

In the illustrated implementation, the database 160 includes priority queue data 174. In some cases, the priority queue data 174 includes an ordered list of pending requests for each network service 110. The priority queue data 174 may be updated by the queue manager 148 in order to affect prioritization of requests.

The illustrated database 160 includes an application registry 176. In some implementations, the application registry 176 includes information about the network services 110 that registered with the cloud system 130 to have requests brokered by the load controller framework 140. In some cases, the application registry 176 may be populated according to a request received from the network services 110, such as through an API. Where a request is received by the cloud system 130, the load controller framework 140 may check the application registry 176 to determine whether it should broker the request for the particular network service 110.

As shown, the database 160 includes load statistics 178. In some implementations, the load statistics 178 may include current load statistics associated with each of the network services 110. The load controller 142 may consult the load statistics 178 to determine whether the each of the network services 110 is currently under load. In some cases, the load statistics 178 may include historical load statistics for each of the network services 110, such that previous load behavior may be analyzed.

The environment 100 may also include one or more network services 110. In some implementations, the network services 110 may be services connected to the cloud system 130 by the network 120. In operation, the network services 110 may receive requests from the clients 180 via the cloud system 130 and may provide responses to these requests to the clients 180 via the cloud system 130. In some cases, the network services 110 may provide responses directly to the clients 180, such that the cloud system 130 does not broker the responses.

In some implementations, the one or more network services 110 may be on-premise services implemented at a customer premise site separate from the cloud system 130. The one or more network services 110 may also be an integrated component within the cloud system 130.

As shown, the one or more network services 110 include one or more applications 114. In some cases, the applications 114 may be software programs executed by the network service 110 and operable to perform analysis associated with the network service 110. The one or more network services 110 may also include a load monitor 112 operable to analyze the current state of the network service 110 and send a flow control indication to the cloud system 130 if the network service 110 is under load. For example, the load monitor 112 may track the current bandwidth used by the network service 110 and send a flow control indication to the cloud system 130 if the current bandwidth used exceeds a configured threshold. In some implementations, at least a portion of the load monitor 112 may be located remotely from the network service 110. In such a case, an agent or client of the load monitor 112 may monitor locally and share gathered information related to the network service 110 with a corresponding component located remotely from the network service 110, such as, for example, in the cloud system 130.

Illustrated client 180 is intended to encompass any computing device, such as a desktop computer, laptop/notebook computer, wireless data port, smart phone, personal data assistant (PDA), tablet computing device, one or more processors within these devices, or any other suitable processing device. For example, client 180 may comprise a computer that includes an input device, such as a keypad, touch screen, or other device that can accept user information and an output device that conveys information associated with the operation of the cloud system 130 or client 180 itself, including digital data, visual information, or a graphical user interface (GUI). Client 180 may include an interface 189, a processor 184, a memory 188 and a client application 186. Client 180 may be used by a user to access the cloud system 130 to view or change items in the database 160, such as rules 170.

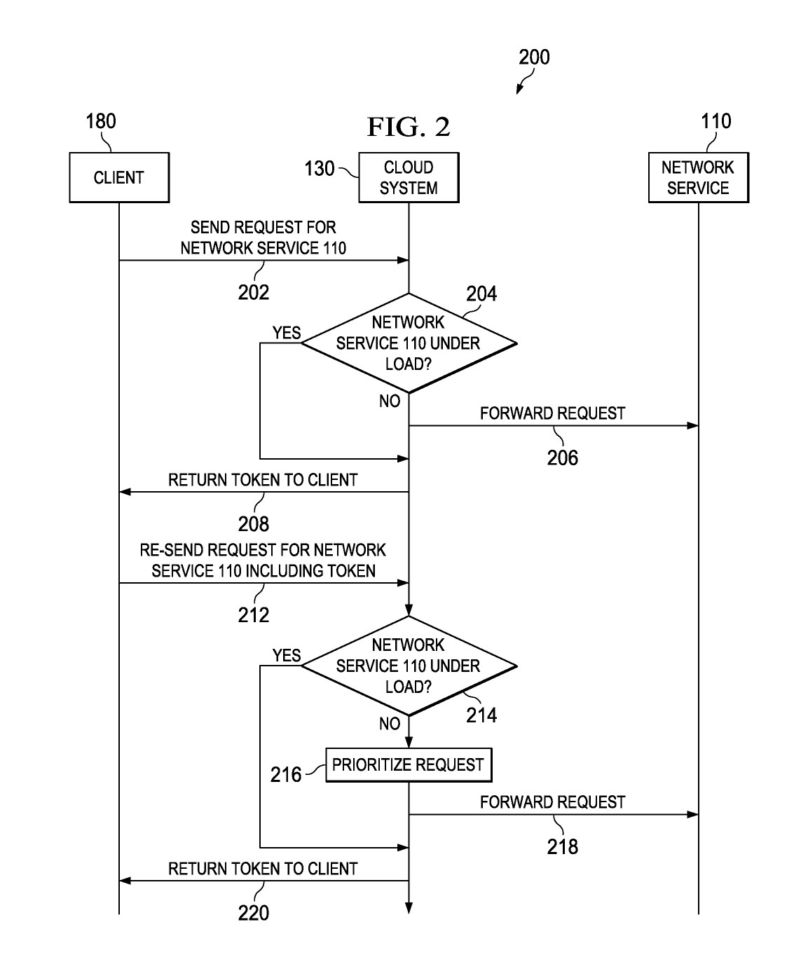

FIG. 2 is a message flow diagram showing an example interaction 200 between a client and a cloud system for controlling service load. For clarity of presentation, the description that follows generally describes interaction 200 in the context of FIG. 1, and specifically, client 180, cloud system 130, and network service 110. However, interaction 200 may be performed, for example, by any other suitable system, environment, software, and hardware, or a combination of systems, environments, software, and hardware, as appropriate. For example, one or more of the cloud system, the client, or other computing device (not illustrated) can be used to execute interaction 200 and obtain any data from the memory of the client, the cloud system, or the other computing device (not illustrated).

At 202, the client 180 sends a request for the network service 110 to the cloud system 130. In some implementations, the client 180 may send the request to the cloud system 130 over the network 120. In some cases, the client 180 may send the request according to an API specific to the cloud system 130.

At 204, cloud system 130 determines if the network service 110 is under load. In some cases, the cloud system 130 make this determination by examining load statistics associated with the network service 110 as discussed relative to FIG. 1. If the cloud system 130 determines the network service 110 is not under load, the flow continues to 206, where the cloud system 130 forwards the request to the network service 110. If the cloud system 130 determines at 204 that the network service 110 is under load, the flow continues to 208, where the cloud system 130 returns the token to the client 180.

At 212, the client 180 resends the request for the network service 110 including the token returned by the cloud system 130 at 208. In some implementations, the client 180 may wait for a certain amount of time before resending the request. The client 180 may also resend the request immediately upon receiving the token from the cloud system 130.

At 214, the cloud system 130 determines whether the network service 110 is under load. For example, the cloud system 130 may determine that the network service 110 is under load by examining the current statistics associated with the network service 110, such as a number of pending requests, an average response time for recent requests, or any other suitable statistic. The cloud system 130 may also determine that the network service 110 is under load based on a flow control indication previously received from the network service 110, as discussed relative to FIG. 1.

If the network service 110 is not under load, the flow continues to 216, where the resubmitted request is prioritized. In some implementations, prioritizing the request includes analyzing token data associated with the token to determine how to prioritize the request. For example, the cloud system 130 may examine the token data 172 to determine a number of times the token has been resubmitted and prioritize the request accordingly. At 218, the request is forwarded to the network service 110. Forwarding the request may occur immediately or may occur after a certain amount of time if other higher priority requests are already pending.

If the network service 110 is determined to be under load at 214, the flow continues to 220 where the token is again returned to the client. In some implementations, the token returned to the client at 220 is identical to the token returned at 208. The token may also be updated to be different with each subsequent retransmission. The cloud system 130 may also update the token data associated with the token in the database 160 to reflect that the token has been resubmitted.

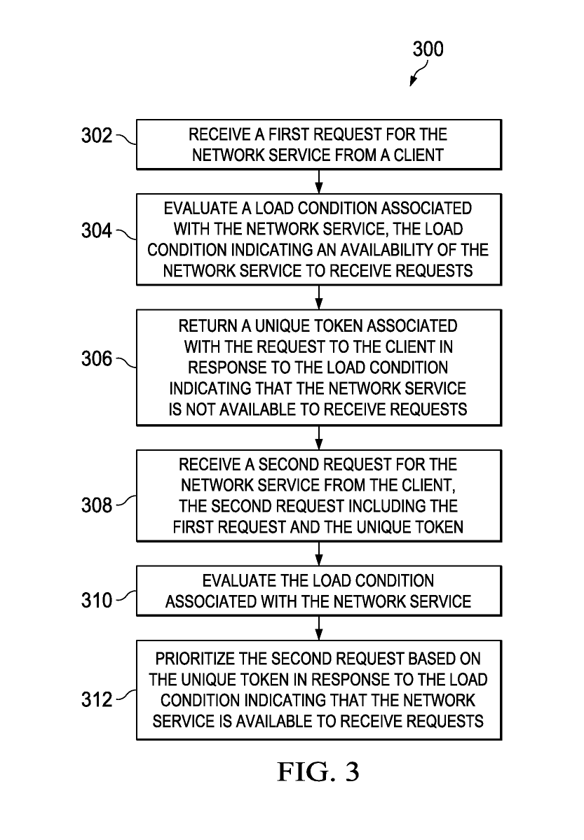

FIG. 3 is a flowchart of an example method 300 for controlling service load in a cloud-based system. For clarity of presentation, the description that follows generally describes method 300 in the context of FIG. 1. However, method 300 may be performed, for example, by any other suitable system, environment, software, and hardware, or a combination of systems, environments, software, and hardware, as appropriate. For example, one or more of the cloud system, the client, or other computing device (not illustrated) can be used to execute method 300 and obtain any data from the memory of the client, the cloud system, or the other computing device (not illustrated).

At 302, a first request for the network service is received from a client. In some implementations, the first request may be a request that has not been previously submitted by the client. In some cases, the first request may be received over a network from the client. The first request may be received according to an API associated with the method 300 or the associated network service.

At 304, a load condition associated with the network service is evaluated, the load condition indicating an availability of the network service to receive requests. In some implementations, the load condition is evaluated according to the techniques previously described relative to FIG. 1. At 306, a unique token associated with the request is returned to the client in response to the load condition indicating that the network service is not available to receive requests. The unique token may include a GUID to distinguish it from other tokens and may have a record associated with it stored in a database (e.g., 160).

At 308, a second request for the network service is received from the client, where the second request includes at least a portion of the first request and the unique token. In some implementations, the second request includes the first request in its entirety with the unique token inserted into the body of the request. The second request may also include a container message including a field for the first request and the unique token. In some implementations, the second request may include any suitable portion of the first request or a reference to the first request.

At 310, the load condition associated with the network service is evaluated. At 312, the second request is prioritized based on the unique token in response to the load condition indicating that the network service is available to receive requests. In some implementations, the prioritization is performed as described relative to FIG. 1

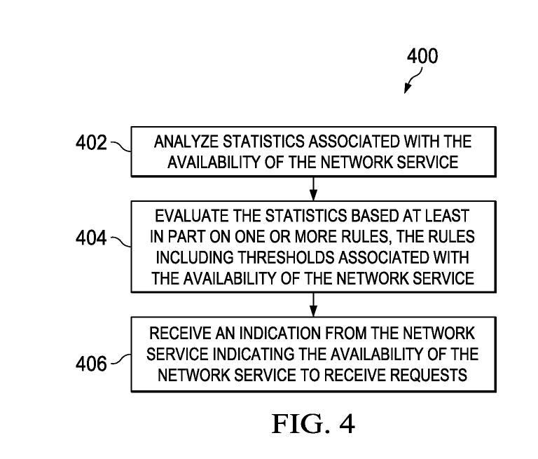

FIG. 4 is a flowchart of an example method 400 for evaluating a load condition associated with a network service. For clarity of presentation, the description that follows generally describes method 400 in the context of FIG. 1. However, method 400 may be performed, for example, by any other suitable system, environment, software, and hardware, or a combination of systems, environments, software, and hardware, as appropriate. For example, one or more of the cloud system, the client, or other computing device (not illustrated) can be used to execute method 400 and obtain any data from the memory of the client, the cloud system, or the other computing device (not illustrated).

At 402, statistics associated with the availability of the network service are analyzed. At 404, the statistics are evaluated based at least in part on one or more rules, the rules including thresholds associated with the availability of the network service. In some implementations, the one or more rules are statically defined. The one or more rules may also be dynamically specified based on runtime conditions associated with the network service, as discussed relative to FIG. 1. At 406, an indication is received from the network service indicating the availability of the network service to receive requests.

The preceding figures and accompanying description illustrate example processes and computer implementable techniques. Environment 100 (or its software or other components) contemplates using, implementing, or executing any suitable technique for performing these and other tasks. These processes are for illustration purposes only and that the described or similar techniques may be performed at any appropriate time, including concurrently, individually, or in combination. In addition, many of the steps in these processes may take place simultaneously, concurrently, and/or in different order than as shown. Moreover, environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

1. A computer-implemented method executed by one or more processors, the method performed at a load controller of a cloud-based network system, the load controller separate from a network service, the method comprising:
receiving a first request for the network service from a client;
evaluating a load condition associated with the network service, the load condition indicating an availability of the network service to receive requests;
returning a unique token associated with the first request to the client in response to the load condition indicating that the network service is not available to receive the requests;
receiving a second request for the network service from the client, the second request including at least a portion of the first request and the unique token;
evaluating the load condition associated with the network service; and
prioritizing the second request based on the unique token in response to the load condition indicating that the network service is available to receive the requests.

2. The method of claim 1, where prioritizing the second request based on the unique token includes sending the second request to the network service before a third request that was received prior to the second request.

3. The method of claim 1, wherein evaluating the load condition associated with the network service further comprises:
analyzing statistics associated with the availability of the network service; and
evaluating the statistics based at least in part on one or more rules, the one or more rules including thresholds associated with the availability of the network service.

4. The method of claim 3, wherein the one or more rules each include one or more actions to be taken when the statistics associated with the availability of the network service indicate that the network service is not available.

5. The method of claim 4, wherein the one or more actions include at least one of: reducing a rate that requests are sent to the network service for a period of time or blocking access to the network service for a period of time.

6. The method of claim 3, wherein the thresholds each include a time value indicating a period of time that the threshold is to be used in evaluating the statistics.

7. The method of claim 1, wherein evaluating the load condition associated with the network service further comprises receiving an indication from the network service indicating the availability of the network service to receive requests.

8. The method of claim 1, wherein the network service is a network service in the cloud-based network system.

9. The method of claim 1, wherein the network service is a customer-premise network service separate from the cloud-based network system.

10. A computer program product encoded on a tangible, non-transitory storage medium, the product comprising computer readable instructions for causing one or more processors to perform operations comprising:
receiving a first request for the network service from a client;
evaluating a load condition associated with the network service, the load condition indicating an availability of the network service to receive requests;
returning a unique token associated with the first request to the client in response to the load condition indicating that the network service is not available to receive the requests;
receiving a second request for the network service from the client, the second request including at least a portion of the first request and the unique token;
evaluating the load condition associated with the network service; and
prioritizing the second request based on the unique token in response to the load condition indicating that the network service is available to receive the requests.

11. The computer program product of claim 10, where prioritizing the second request based on the unique token includes sending the second request to the network service before a third request that was received prior to the second request.

12. The computer program product of claim 10, wherein evaluating the load condition associated with the network service further comprises:
analyzing statistics associated with the availability of the network service; and
evaluating the statistics based at least in part on one or more rules, the one or more rules including thresholds associated with the availability of the network service.

13. The computer program product of claim 12, wherein the one or more rules each include one or more actions to be taken when the statistics associated with the availability of the network service indicate that the network service is not available.

14. The computer program product of claim 13, wherein the one or more actions include at least one of: reducing a rate that requests are sent to the network service for a period of time or blocking access to the network service for a period of time.

15. The computer program product of claim 12, wherein the thresholds each include a time value indicating a period of time that the threshold is to be used in evaluating the statistics.

16. The computer program product of claim 10, wherein evaluating the load condition associated with the network service further comprises receiving an indication from the network service indicating the availability of the network service to receive requests.

17. The computer program product of claim 10, wherein the network service is a network service in the cloud-based network system.

18. The computer program product of claim 10, wherein the network service is a customer-premise network service separate from the cloud-based network system.

19. (canceled)

20. The system of claim 21, where prioritizing the second request based on the unique token includes sending the second request to the network service before a third request that was received prior to the second request.

21. A system, comprising:
memory for storing data; and
one or more processors operable to perform operations comprising:
receiving a first request for the network service from a client;
evaluating a load condition associated with the network service, the load condition indicating an availability of the network service to receive requests;
returning a unique token associated with the first request to the client in response to the load condition indicating that the network service is not available to receive the requests;
receiving a second request for the network service from the client, the second request including at least a portion of the first request and the unique token;
evaluating the load condition associated with the network service; and
prioritizing the second request based on the unique token in response to the load condition indicating that the network service is available to receive the requests.
